(19) United States
(12) Patent Application Publication
(10) Pub. No.: US 2003/0165339 A1
(43) Pub. Date: Sep. 4, 2003

(54) Development apparatus

(76) Inventor: David Francis Garrity, West Yorkshire (GB)

Correspondence Address: MICHAEL BEST & FRIEDRICH, LLP, 100 E WISCONSIN AVENUE, MILWAUKEE, WI, 53202, US

(21) Appl. No.: 10/275,420

(22) PCT Filed: Apr. 25, 2001
(86) PCT No.: PCT/GB01/01832

(30) Foreign Application Priority Data
May 5, 2000 (GB) 0010813.4

(51) Int. Cl. G03D 5/00

(52) U.S. Cl. 396/604

(57) ABSTRACT

Development fluid extends up to and contacts the underside of the transparent cover (18). The normal height of the fluid is shown by line (36). A leading edge (18A) of the coveris inclined upwardly and includes acut-out portion (38). As a result of surface tension, the meniscus of the chemical rises up into the cut-out portion (38). As the leading edge of the plate part is beneath the inclined leading edge (18A), the top surface of the plate comes into contact with the chemical at the region where the curved line formed by the surface tension of the chemical (40) extends into the cut-out portion to coat the plate in a straight line across the width of the machine.

The present invention relates to a method of coating an upwardly facing surface of an article, development coating apparatus, a method of controlling the temperature of a fluid in development apparatus, development fluid temperature control apparatus, a development fluid apparatus, a driving arrangement, a fluid development reservoir, fluid dispense apparatus and a method of dispensing fluid.

According to one aspect of the present invention a method of coating an upwardly facing surface of an article with development fluid comprises causing development fluid to rise above its natural height as a result of surface tension and moving the article such that the top surface thereof passes the development fluid in the region where the fluid is caused to rise above its natural height whereby the top surface of the article is coated with development fluid.

The method may comprise causing a substantially linear region of the article to be coated with development fluid as it contacts the fluid in the region where it is caused to rise above the natural height. The method may comprise causing substantially the complete width of the article to be coated with development fluid.

The method may comprise causing the fluid to rise above its natural height by the fluid contacting an edge of an apparatus that is at an angle with respect to the horizontal and that angle may be perpendicular. The method may comprise causing the fluid to contact an edge that is above the natural height of the fluid and that edge may extend transverse to the vertical and may be substantially horizontal. The fluid may contact an edge that extends initially upwardly and then along in order to rise up above its natural height.

The method may comprise adjusting the height of the edge relative to the natural height of the fluid and the edge may be adjusted at at least two spaced locations.

The method may comprise causing the development fluid to continue to rise above its natural height as a result of surface tension after the leading portion of an article has reached the location where the development fluid rises and the method may comprise fluid continuing to rise above its natural height after the leading portion has passed a location where the level rises and the level may be caused to rise for substantially the whole time that the article is passing the location where the level rises and may so rise after the article has passed that location.

The level may be caused to rise across an extent that is transverse to the direction of movement of the article.

The method may comprise feeding the article in a downwardly inclined direction towards the location where the fluid rises. The method may comprise causing the article to bend at the location where the fluid rises or after the location where the fluid rises or both such that the article is caused to extend in an upwardly inclined direction to rise above the natural height of the fluid. The article may be caused to leave the natural height of the fluid at a region that also has development fluid rising above its natural height as a result of surface tension.

The method may comprise causing the article to take a predetermined time between the point where a part of the surface is coated with fluid at a region where the level of the fluid is caused to rise than a region where the development fluid is removed. The method may comprise ensuring that each portion of the plate is coated for a duration varying less than 3% or less than 2%.

The method may comprise viewing the top surface of the article as it passes the location where the development fluid has been caused to rise, for instance through a transparent portion. The method may comprise viewing an article after it has passed the region where the fluid has been caused to rise, for instance through a transparent portion.

The method may comprise monitoring the level of development fluid and adjusting the level of development fluid to ensure that the level remains substantially constant.

The method may comprise removing fluid from across the width or substantially the whole width of the development fluid. The method may comprise supplying development fluid across the whole width or substantially the whole width of the development fluid.

The method may comprise causing different thicknesses of articles to move past the region where the level has been caused to rise to coat the top surfaces of those different articles.

The method may comprise the coating of articles in a batch process.

According to a further aspect of the present invention development coating apparatus comprises a fluid development region that is arranged, in use, to contain development fluid and an edge region that is arranged to extend across the fluid development region such that, when fluid is located in the development region, it is caused to rise above the natural height of that fluid by contact with the edge region, which edge region is arranged to be located where the leading top surface of an article to be coated first comes into contact with the fluid.

The edge region may be transparent. The edge region may comprise part of a downwardly facing surface extending downstream with respect to the direction of travel of an article. That downwardly facing surface may be arranged, in use, to contact development fluid. The downwardly facing surface may be transparent.

The apparatus may include a guide arranged to deflect a plate from extending downwardly after an article passes the edge region to extending upwardly and above the level of the fluid after the leading part of the article has passed the edge region.

The apparatus may comprise article conveyor means arranged to direct the article downwardly towards the edge region.

According to a further aspect of the present invention a method of controlling the temperature of a fluid in development apparatus comprises removing fluid from a tank and passing the fluid through a semi conductor heat exchange unit, monitoring the temperature of the fluid and controlling the semi conductor heat exchanger to increase or decrease the temperature of the fluid and then returning fluid to the tank in order to maintain the temperature of the fluid in the tank in the region of a set temperature.

The method may comprise altering the polarity of current supplied to the semi conductor heat exchanger to respectively heat or cool the fluid. The method may comprise pumping the fluid.

The method may comprise maintaining the temperature of the fluid substantially constant across substantially the complete extent of the tank.

The method may comprise causing the fluid to exchange heat with the semi conductor unit directly, for instance without the use of any intermediate heat exchange fluid.

The method may comprise passing the fluid from the tank through a filter before returning the fluid to the tank.

The method may comprise removing fluid from the tank from a plurality of locations across the tank and preferably from across substantially the whole width of the tank. The method may comprise returning fluid to the tank at a plurality of positions across the tank and preferably across substantially the whole width of the tank.

According to a further aspect of the present invention development fluid temperature control apparatus comprises a development fluid tank, connection means connecting fluid in the tank to a semi conductor heat exchange unit remote from the tank, connection means for returning fluid from the semi conductor heat exchange unit to the tank, temperature monitoring means arranged to monitor the temperature of fluid and control means for the heat exchanger arranged, in use, to increase or decrease the temperature of the fluid in order to maintain the temperature of the fluid in the tank in the region of a set temperature.

The temperature monitoring means may be located in the tank.

According to a further aspect of the present invention, development fluid apparatus comprises a reservoir for development fluid and a reservoir for washing fluid, the development reservoir and the washing reservoir being formed from an integrally formed moulding.

The moulding may be plastics and may be vacuum formed.

The moulding may include a drain for at least one of the reservoirs.

The moulding may include side walls to which rollers are arranged to be connected, for instance by being directly connected to the side walls. Alternatively or additionally, at least one of the rollers may be connected to an attachment to one of the side walls.

The moulding may include at least one opening through which a drive for a roller is arranged to extend. In use, the opening may be arranged to be clear of fluid in a reservoir and the opening may be arranged to be above an opening in the reservoir. All openings that are above reservoirs may be arranged to be clear of the reservoirs.

The moulding may include two reservoirs adjacent to each other with a wall separating those reservoirs. In use, fluid from one reservoir may be arranged to flow over the wall to the other reservoir.

According to another aspect of the present invention a driving arrangement comprises a drive means and a driven means, the drive and driven means being arranged to engage each other by at least one generally axially extending surface on one means cooperating with a corresponding generally axially extending surface on the other means.

The drive and driven means may be rotatable to a position in which one of said means is able to move in a radial direction relative to the other whereby the means may be disengaged.

At least one of the generally axially extending surfaces may comprise an axial projection from the means on which it is located which may extend towards the other means.

At least one of the drive or driven means may include a member that is mounted on the shaft which member includes the generally axially extending surface, the member being movable on the shaft. At least part of the member may at least partially surround the shaft with a clearance. The member may be loosely connected to the shaft. The member may be able to swivel on the shaft and alternatively or additionally, may be movable to rock about the axis of the shaft, for instance in all relative directions.

The drive and driven means may be arranged to be located within an integrally formed moulding as herein referred to.

According to a further aspect of the present invention, a fluid development reservoir includes means for supplying fluid that has had its temperature altered to a desired value at a plurality of locations across the reservoir.

In use, fluid may be supplied across substantially the complete width of the reservoir.

The reservoir may include fluid removal means arranged, in use, to remove fluid from a plurality of locations across the reservoir and may comprise removing that fluid across substantially the complete width of the reservoir. The removed fluid may subsequently have its temperature altered to a desired value prior to being supplied to the reservoir.

The present invention also includes a method of supplying fluid to a fluid development reservoir as herein described.

According to a further aspect of the present invention, fluid dispense apparatus comprises means for supplying fluid to an elongate dispense means at a location spaced from the ends of the dispense means with that fluid then being arranged, in use, to be dispensed from the dispense means.

The means for supplying fluid may comprise an elongate supply means arranged to extend at least partially and preferably in substantially the same direction as the dispense means. The supply means may be adjacent to the dispense means. The elongate supply means may be arranged to have fluid supplied thereto from an end region adjacent to an end region of the dispense means.

The apparatus may include connection means arranged to seal with the supply means and the dispense means and to provide a connection between the supply and dispense means. The connection means may be arranged to surround the supply or the dispense means or both.

The supply means and the dispense means may be arranged to be connected together at at least one end for instance by a connection member which may include an opening for each means. The connection member may be arranged to be removably received in a mounting recess.

The apparatus may include two elongate dispense means extending in generally the same direction.

The dispense means may comprise spray means.

The present invention also includes a method of dispensing fluid using apparatus as herein referred to. The fluid may be dispensed at a greater pressure in a central region of the dispense means than at an end region of the dispense means. The pressure of fluid at the central region may be more than 10 or more than 20 or more than 30 or more than 40% of the pressure at the end region.

The present invention includes any combination of the herein referred to features or limitations.

The present invention can be carried into practice in various ways but one embodiment will now be described, by way of example, and with reference to the accompanying drawings, in which:

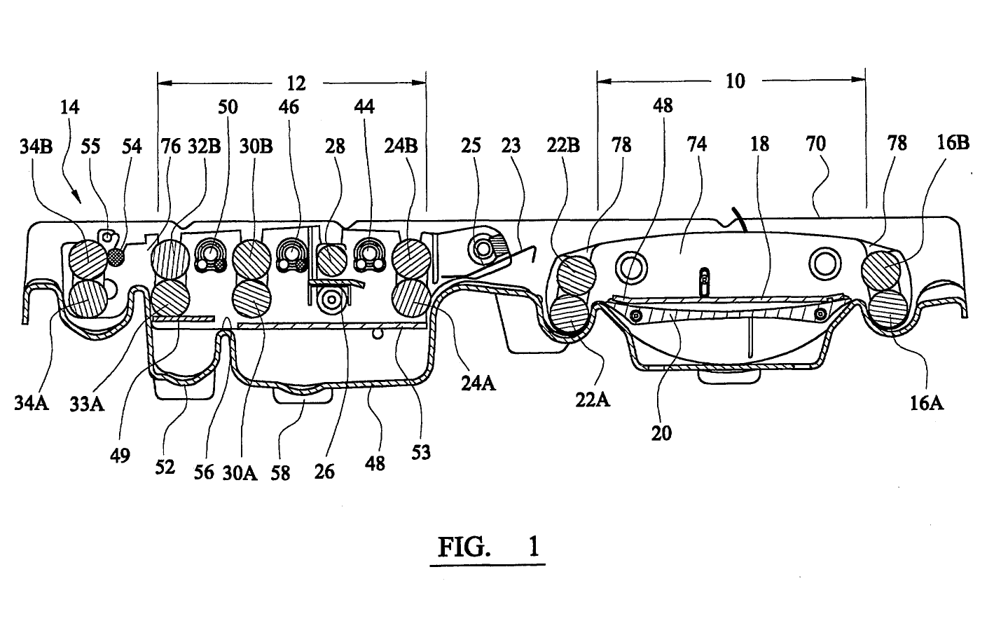

FIG. 1 is a cross-sectional view along the length of a diffusion transfer machine;

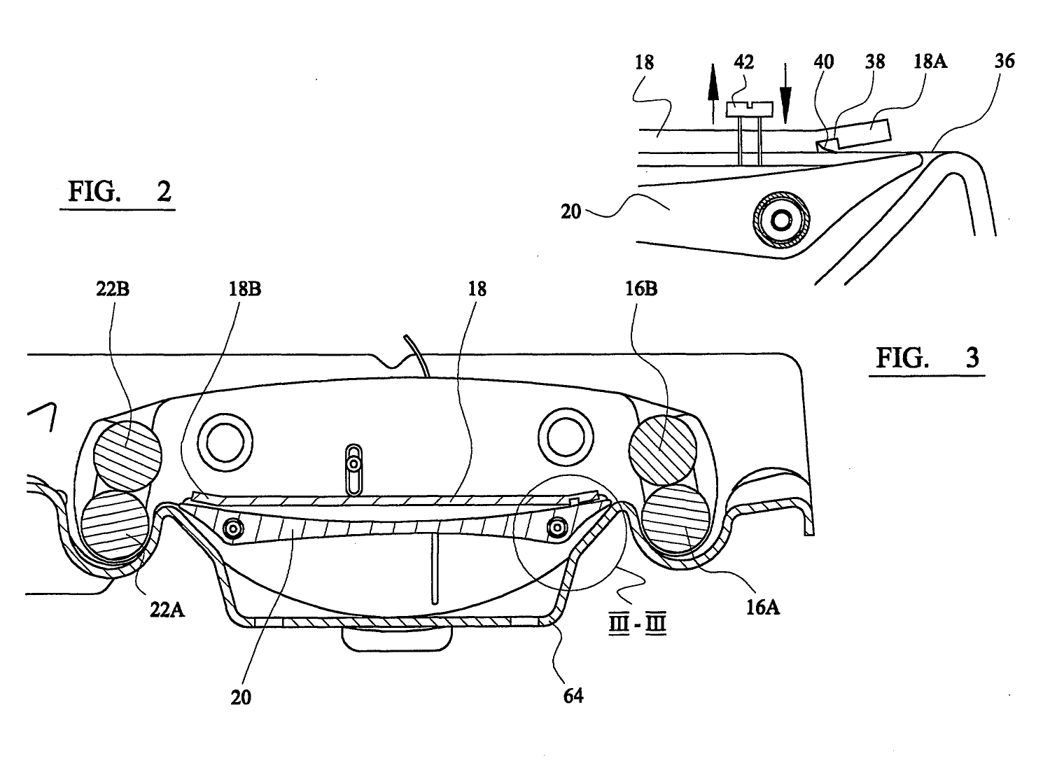

FIG. 2 is a close up of the development section;

FIG. 3 is a close up of part of the development section shown with the circle marked III-III in FIG. 2;

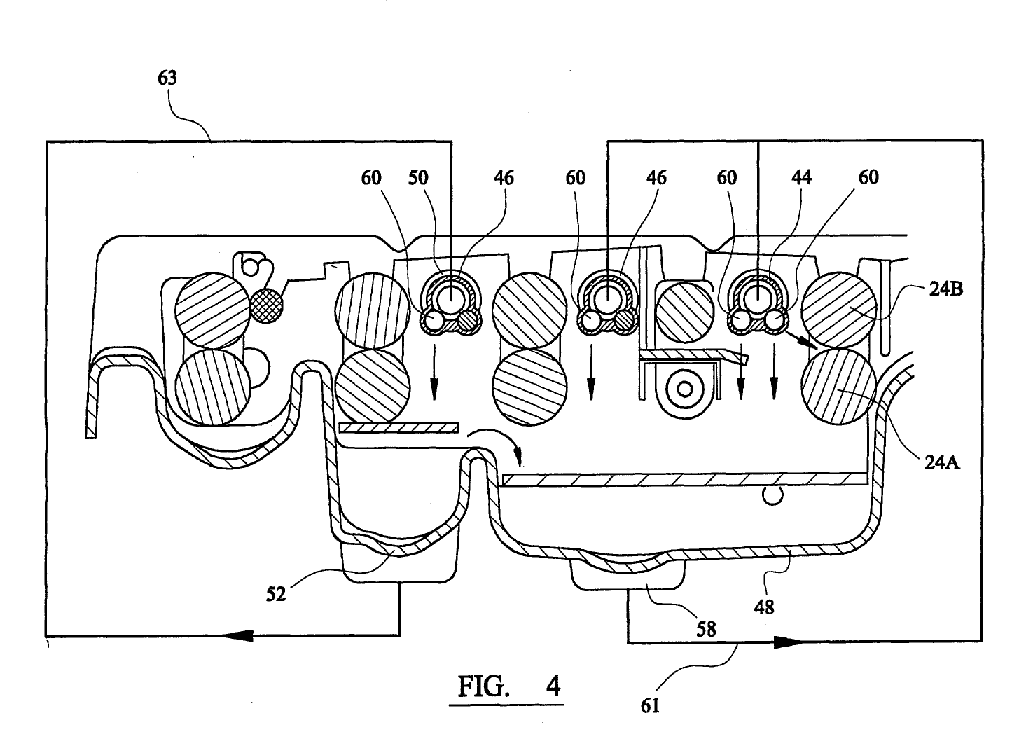

FIG. 4 is a detail showing the washing part of the machine;

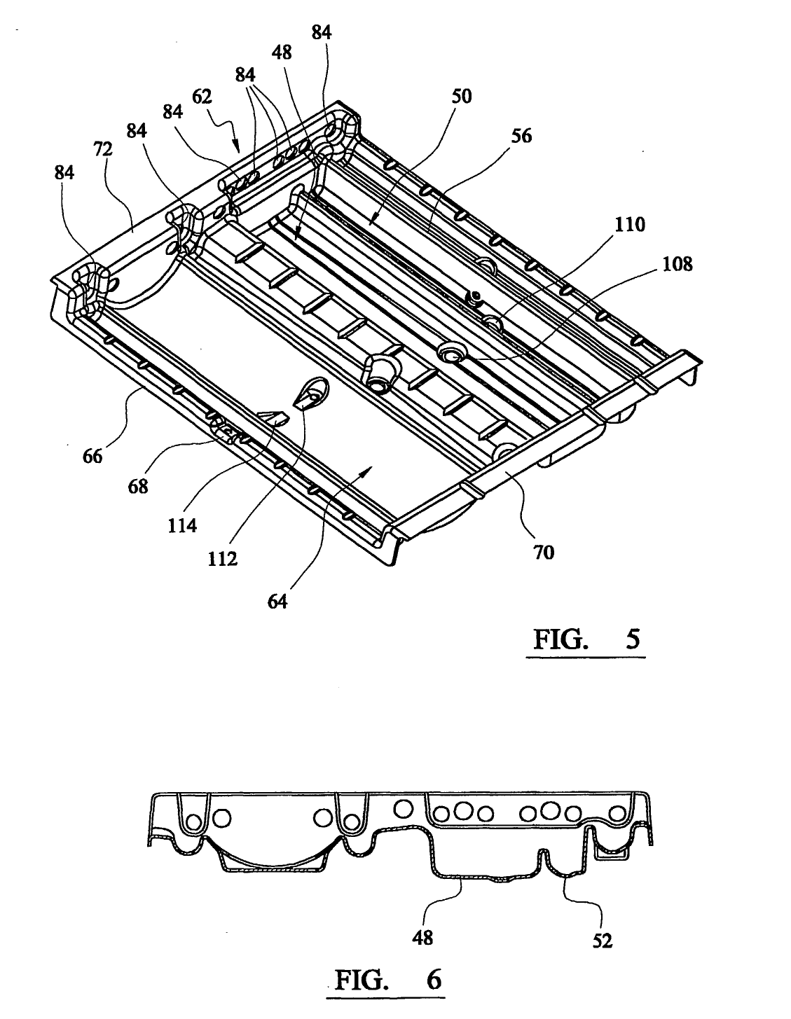

FIG. 5 is a perspective view showing the vacuum formed processor tank used in the machine;

FIG. 6 is a cross-section taken along the length of the machine shown in FIG. 5;

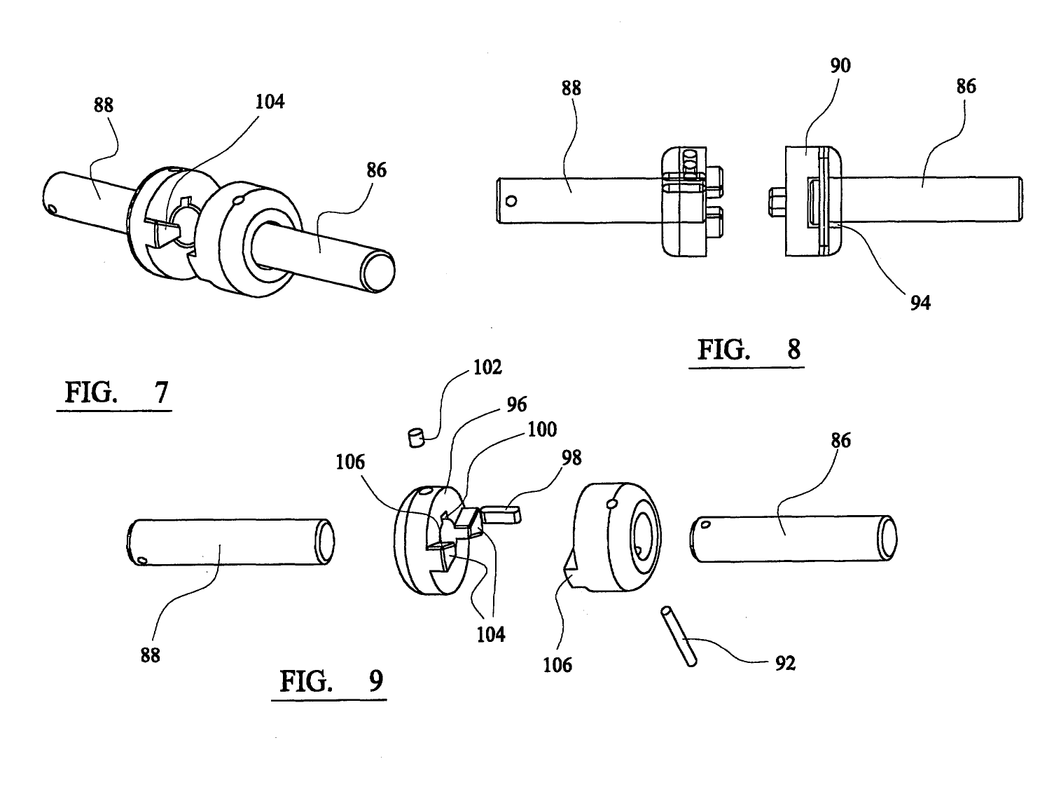

FIG. 7 is a perspective view showing the coupling arrangement used for driven rollers in the machine;

FIG. 8 is a side view of FIG. 7;

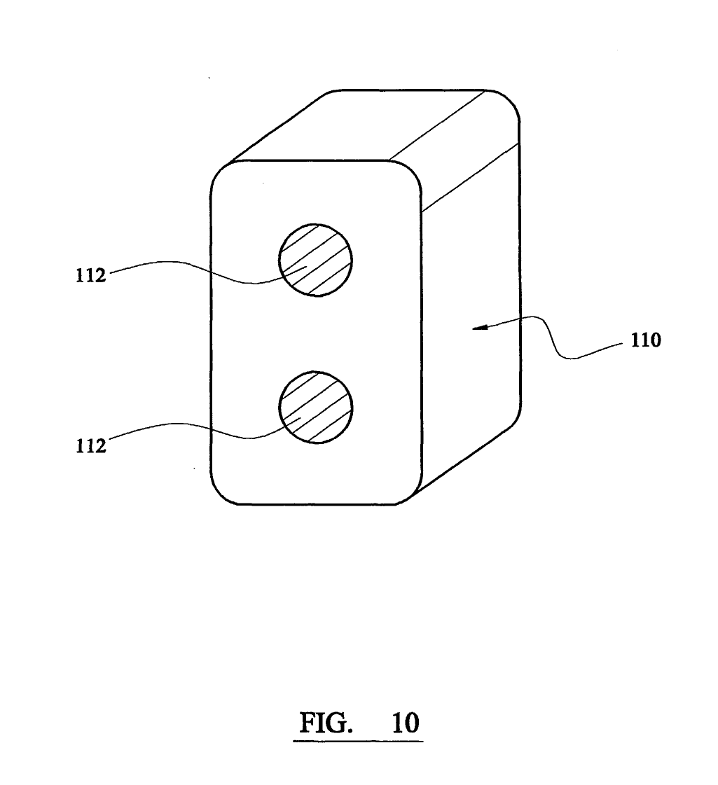

FIG. 9 is an exploded perspective view of the parts shown in FIGS. 7 and 8;

FIG. 10 is a schematic perspective view of a housing for the shafts of the ends of the rollers;

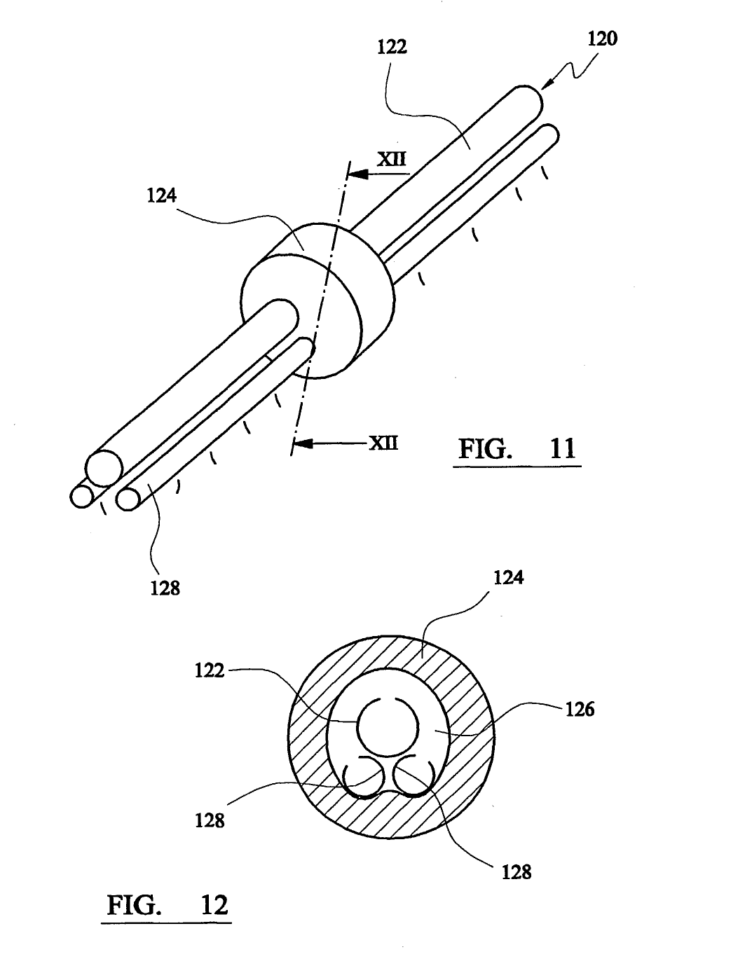

FIG. 11 is a schematic perspective view of a spray pipe, and

FIG. 12 is a section through XII-XII of FIG. 11.

As shown in FIG. 1, the machine includes a silver diffusion transfer section 10, a washing section 12 and a gum application section 14.

In use, a plate to be developed is fed in between the rollers 16A and 16B and beneath a cover 18 and over a support 20 before passing through cooperating rollers 22A and 22B. As the plate leaves the rollers 22A and 22B it leaves the diffusion transfer section and enters the washing section 12. On entering the washing section, the plate passes between rollers 24A and 24B before passing over a supporting platform 26 above which a brushing roller 28 is located and then passing between co-operating rollers 30A and 30B and then co-operating rollers 32A and 32B. Finally, the sheet passes the co-operating gumming rollers 34A and 34B.

The silver diffusion transfer section 10 includes developer fluid that extends up to and contacts the underside of the cover 18 along the majority of its extent. Referring to FIG. 3, the diffusion chemical is at the height shown by the line 36. A leading edge 18A of the cover 18 is inclined upwardly slightly with respect to the remainder of the horizontal cover 18. The underside of the cover 18 includes a cut-out portion 38 at the junction between the cover 18 and the leading edge 18A that extends across the width of the cover. Because of the surface tension effect of the chemical, the meniscus of the chemical in the region of the cut-out portion 38 rises up into the cut-out portion, as shown by the curved line 40. If desired, the trailing edge 18B can also have a similar cut-out portion 38 to that of the leading edge 18A in order to maintain a straight meniscus edge as the plate leaves the straight section of the cover 18.

The axes of the rollers 16A and 16B are offset from each other slightly with the axis of the upper portion being spaced slightly to the left of the axis of the lower roller 18A, when viewed in FIG. 2. This ensures that the plate is obliged to enter at approximately the same angle as the inclination of the leading edge 18A such that the plate is fed between the cover 18 and the support 20.

As the leading edge of the plate passes beneath the inclined leading edge 18A the top surface of the plate comes into contact with the chemical at the region where the curved line formed by the -surface tension of the chemical 40 extends into the cut-out portion 38. The plate thus becomes coated in a straight line across the width of the machine in the region of the curved line 40. The cover 18 and the leading edge 18A are of transparent material such that an operator setting up the machine can check and see that the chemical being deposited on the surface of the plate is in a straight line across the plate. Spaced adjustment screws 42 can be rotated to raise or lower the plate to ensure that the chemical is applied in a straight line across the plate.

The plate then bends slightly along the angle defined by the support 20 by sliding over the support with the top surface remaining covered in developer chemical before leaving the trailing part of the cover 18 at an upwardly inclined trailing edge 18B. The sheet then passes between the rollers 22A and 22B. These remove excess development chemical fluid from the plate but leave the surface with active chemical on the plate. The axis of the roller 22B is offset slightly to the right of the axis of the lower roller 22A to receive the plate in a tangential direction with respect to each of those rollers.

As the plate encounters the upwardly inclined edge 18B the plate is no longer immersed in diffusion chemical. Nevertheless, it remains covered in that chemical. The chemical is removed by the rollers 24A and 24B in a manner to be described later. The significance of the leading edge 18A of the cover being able to apply the chemical in a straight line is critical in the development of plates. If the chemical is not applied in a straight line then one width of plate will have the chemical applied to it at an earlier time than another width and as a difference of 0.5 seconds over a desired development time of 20 seconds can be sufficient to over develop or under develop the plate it can be seen how important this feature is.

The plate then enters the washing section 12 through the rollers 24A and 24B. Spaced wash pipes 44 and 46 then spray wash chemistry down on to the top surface of the plate with that chemical falling down into the tank 48. The chemical in the silver diffusion transfer section either removes the positive image by taking parts of silver on the plate into solution or removes the negative part of the image in the same way. Consequently, small pieces of silver will accompany the plate into the wash section. The wash chemical sprayed by the pipes 44 and 46 across the width of the plate and the brushing roller 28 remove most of the debris from the top of the plate and carries it down into the tank 48. The plate then passes between the rollers 30A and 30B and past a further wash pipe 50 that sprays further wash chemistry on to the plate to further rinse the plate. The wash chemistry from the pipe 50 enters a tank 52.

The plate then leaves the rollers 32A and 32B and passes between the rollers 34A and 34B. A gumming roller 54 transfers gum to the upper roller 34B which is in turn transferred to the top surface of the printing plate by the roller 34B. Gum is transferred to the space between the rollers 54 and 34B by a spray pipe 55. A dam of gum builds up between these rollers and the thickness of gum that is transferred to the plate by the roller 34B is determined by the spacing or pressure of nip between the rollers 54 and 34B.

The wash chemistry in the tank 52 is relatively clean. This wash chemistry flows over a wall 56 of the tank 52 into the tank 48. The level of wash chemical in the tank 48 is kept lower than the height of the wall 56 of the tank 52. The wash chemistry from the tank 48 is drained into a channel 58 from where it is pumped through two filters first to remove particles above 20 microns and then to remove particles above 5 microns. From there, it is supplied to the wash pipes 44 and 46 via the supply 61.

Excess chemistry from the tank 48 passes out to a drain (not shown) in order to stop the tank 48 from overflowing. This excess chemistry passes over the top of a pipe (not shown) which extends up through the bottom of the tank to the desired maximum level of fluid. In addition, the tank 48 and the tank 64 will have level sensors that control the level of fluid in those tanks by controlling the flows thereto.

Fresh washing chemistry is supplied to the wash pipe 50 via the supply 63 with that fresh chemistry then flowing over into the tank 48 from the tank 52.

As can be seen in FIG. 4, the wash pipe 44 sprays from two parallel passages 60 whereas the wash pipes 46 and 50 only spray through a single passageway 60. In this way the spray from the pipe 44 coats the rollers 24A and 24B with wash chemical so that as their surfaces nip the plate passing through them the active development chemical is rendered inactive and development stops.

Each of the rollers 16A, 16B; 22A, 22B; 24A, 24B; 30A, 30B; 32A, 32B; 34A, 34B have each end held in the housing 110 shown in FIG. 10 with the axle from one roller being located in the opening 112 and the axle from the other roller being in the opening 114. (Similarly the ends of the spray pipes and the supply for the spray pipes may be located in the housing). In this way the rollers are held together in a predetermined axial relationship. Without a plate being located between the rollers, a resilient cover on each roller is compressed slightly by their axial spacing being fixed such that rotation of one roller causes rotation of the other roller. When the plate passes between the rollers it further compresses each resilient covering with one of the rollers being driven by means described later and with the other roller being driven by the underside of the moving plate.

The upper rollers may each be driven and may be connected by chains and gears to a common drive. In this instance, the axle of the roller will pass through the opening 112 in the housing.

The vacuum moulding includes a tank 64 that is located beneath the support 20 in the diffusion transfer section, the tank 48 and the tank 52. The leading edge 66 of the tank 64 includes a mounting area 68 for a plate sensor (not shown) that, in use, senses the plate being advanced towards the rollers 16A and 16B and starts all the rollers rotating and the wash pipes spraying at an appropriate time. Similarly the sensor determines the length of the plate and stops the wash pipes when required.

Control means are also provided to add development or wash chemical at the desired rate in accordance with that which a given length or width of plate is estimated to carry with it.

Each tank 48 and 52 include a floating plate 49 and 53 respectively that covers the surface of wash chemical in the tank to inhibit oxidation of the wash chemical.

The side walls 70 and 72, as seen in both FIG. 1 and FIG. 5, includes two mouldings 74 and 76 secured thereto but spaced therefrom. The moulding 74 extends between the rollers 16A and B and 22A and B in the diffusion transfer section 10. The moulding 74 comprises a relatively thick plate including channels 78 that locate the housings 110 at the required angle and position. Similarly, the moulding 76 includes channels for the housings of the other rollers, including the gum roller 54 and openings for the wash pipes.

The side wall 72 includes openings 84 to accommodate the wash pipes and the drive shaft for the upper rollers.

FIGS. 7, 8 and 9 show how a drive shaft 86 is rotatably engageable with a driven shaft 88 of each roller. The drive shaft 86 that, in use, will extend through an opening 84 includes a head 90 that is loosely connected to the drive shaft 86 by a pin 92 that passes through aligned openings in each part. The head 90 includes a recess 94 that is larger than the diameter of the drive shaft 86. The head 90 is thus able to “wobble” on the shaft 86. The head 96 that is mounted on the shaft 88 is securely fixed thereto by a key 98 extending into a groove 100 on an internal section of the head 96 with a threaded member 102 being screwed down in a radial direction through the head to bear against the key 98 to urge it into contact with the shaft 88. The heads 90 and 96 are located between mouldings 74 and 76 and the side wall 72.

Each head includes diametrically opposed outwardly extending projections 104 that face each other. These projections include axially extending faces 106 that are inclined towards the axis of rotation. These faces 106 are able to abut each other such that rotation of the head 90 causes rotation of the head 96. It can be seen that, when the projections 104 on the head 96 are located one above the other, the housing 110 and the rollers can simply be lifted out to repair or replace the rollers with the same or new rollers having their housings dropped into position. The housings at the other end can simply be pulled out of their opening.

The apparatus shown is suitable for plates of any thickness but may in particular be suitable for plates of 0.15 to 0.4 mm.

The developer chemical in the transfer section 10 is extremely expensive. In prior machines it is necessary to completely immerse the plates in the liquid and thus the tank must hold a significant amount of developer chemical. The present machine only requires approximately 20 litres of developer chemical as compared to a prior requirement of 45 litres.

Similarly, none of the driving parts of the upper rollers are immersed in the liquid. Consequently, these parts tend to remain running free for considerably longer than in prior machines. In addition, because the tank is formed from a one piece vacuum moulding, there are no sharp edges provided on the tank on which deposits can build up to decrease the efficiency of the machine and ultimately require the machine to be closed down at frequent periods for cleaning or replacement of parts.

The drains 108 and 110 for the tanks 48 and 52 respectively are integrally formed with the vacuum moulding. The tank 64 for the developer chemical includes an outlet 112 and an inlet 114. The developer chemical can be passed through a Peltier semi conductor heat exchange unit via a pump. The developer chemical passes through pipes of 20 mm diameter between a pair of Peltier plates on each side. The outermost plates with respect to the pipes can be coupled to heat exchange plates which can in turn have air passed over them by fans to assist cooling. A heat sensor in the tank 64 is provided (not shown) that can control the Peltier heat exchanger by altering the charge to be positive or negative to the plates to cause them either to exert a chilling effect or a heating effect on the liquid in the pipes that come from and return to the tank 64. This differs from prior developer heaters where a heating element is immersed in the tank of developer fluid. Such heating elements, when located in the tank, inevitably create hot and cold spots and furthermore render themselves liable to the build up of deposits which require servicing. In addition, the prior tanks must be big enough and contain enough liquid to accommodate the heating elements in the tank. The developer is maintained in the tank at 22° C. The level of the development fluid and, alternatively or additionally, the level of either or both of the washing chemicals may be monitored and the level may be adjusted to ensure that the level remains substantially constant.

As shown in FIGS. 11 and 12, each spray pipe 18 includes an inlet 120 into an elongate tube 122. Liquid fills that tube, which tube is closed at the end opposite to the inlet. A central manifold 124 includes a recess 126 in its central region to enable liquid to flow from the tube 122 into the spray pipes 128 in their central region. Liquid then exists the pipes 128 with a greater pressure in their central region than at the outer extents of those pipes. The pressure may be 20 to 40% greater at the central region than at the ends. The spray pipes may be connected to the inlet and outlet of the development tank 64 to ensure that correct temperature development chemical is diffused across the width of the tank (or to ensure that chemical is removed from across the development tank, in which case fluid flow is reversed). This creates a steadily constant recirculation across the tank to ensure that there are cold or hot spots.

The developing fluid may be passed through a filter either before reaching the heat exchanger or after.

The liquid in the wash section is maintained at 32° C.

FIG. 1 also shows an arrangement comprising a feed in plate 23 and a roller 25 through which a plate to be washed only can be fed thereby by-passing the development stage.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extend to any novel one, or any novel combination, of the features disclosed in this specification (including any accompanying claims, abstract and drawings), or to any novel one, or any novel combination, of the steps of any method or process so disclosed.

1. A method of coating an upwardly facing surface of an article with development fluid comprising causing development fluid (40) to rise above its natural height (36) as a result of surface tension and moving the article such that the top surface thereof passes the development fluid in the region where the fluid is caused to rise above its natural height whereby the top surface of the article is connected with development fluid.

2. A method as claimed in claim 1 comprising causing a substantially linear region of the article to be coated with development fluid as it contacts the fluid (40) in the region where it is caused to rise above the natural height.

3. A method as claimed in claim 2 comprising causing substantially the complete width of the article to be coated with development fluid.

4. A method as claimed in any preceding claim comprising causing the fluid to rise above its natural height by the fluid contacting an edge of an apparatus that is at an angle with respect to the horizontal.

5. A method as claimed in claim 4 in which the edge is perpendicular to the horizontal.

6. A method as claimed in any preceding claim comprising causing the fluid to contact an edge of an apparatus that is above the natural height of the fluid.

7. A method as claimed in claim 6 in which the edge extends transverse to the vertical.

8. A method as claimed in claim 7 in which the edge extends substantially horizontally.

9. A method as claimed in any of claims 4 to 8 comprising the fluid contacting an edge of the apparatus that extends initially upwardly and then along in order for the fluid to rise up above its natural height.

10. A method as claimed in any of claims 4 to 9 comprising adjusting the height of the apparatus relative to the natural height of the fluid.

11. A method as claimed in claim 10 comprising adjusting the height of the edge relative to the natural height of the fluid at at least two spaced locations.

12. A method as claimed in any preceding claim comprising causing the development fluid to continue to rise above its natural height as a result of surface tension after the leading portion of an article has reached a location where the development fluid rises.

13. A method as claimed in claim 12 comprising development fluid continuing to rise -above its natural height after the leading portion of an article has passed a location where the level rises above its natural height.

14. A method as claimed in claim 12 or 13 in which the development fluid is caused to rise above its natural height for substantially the whole time that an article is passing the location where the level rises above its natural height.

15. A method as claimed in any of claims 12 to 14 in which the level of the development fluid is caused to rise above its natural height after an article has passed that location.

16. A method as claimed in any preceding claim in which the level of the development fluid is caused to rise across an extent that is transverse to the direction of movement of the article.

17. A method as claimed in any preceding claim comprising feeding the article in a downwardly inclined direction towards the location where the fluid rises.

18. A method as claimed claim 17 comprising causing the article to bend at the location where the fluid rises.

19. A method as claimed in claim 17 or 18 comprising causing the article to bend after the location where the fluid has been caused to rise above its -natural height such that the article is caused to extend in an upwardly inclined direction to rise above the natural height of the fluid.

20. A method as claimed in any preceding claim in which the article is caused to leave the natural height of the fluid at a region that also has development fluid rising above its natural height as result of surface tension.

21. A method as claimed in any preceding claim comprising causing the article to take a predetermined time between the point where a part of the surface is coated with fluid at a region where the level of the fluid is caused to rise and a region where the development fluid is removed.

22. A method as claimed in any preceding claim comprising viewing the top surface of the article as it passes the location where the development fluid has been caused to rise above its natural height.

23. A method as claimed in any preceding claim comprising viewing the top surface of an article after it has passed the region where the fluid has been caused to rise above its natural height.

24. A method as claimed in any preceding claim comprising monitoring the level of development fluid and adjusting the level of development fluid to ensure that the level remains substantially constant.

25. A method as claimed in any preceding claim comprising removing fluid from across substantially the whole width of the development fluid.

26. A method as claimed in any preceding claim comprising supplying development fluid across substantially the whole width of the development fluid.

27. A method as claimed in any preceding claim comprising causing different thicknesses of articles to move passed a region where the level has been caused to rise above its natural height to coat the top surfaces of those different articles.

28. A method as claimed in any preceding claim comprising coating articles in a batch process.

29. Development coating apparatus comprising a fluid development region that is arranged, in use, to contain development fluid and an edge region that is arranged to extend across the fluid development region such that, when fluid is located in the development region, it is caused to rise above the natural height of that fluid by contact with the edge region which edge region is arranged to be located where the leading top surface of an article to be coated first comes into contact with the fluid.

30. Apparatus as claimed in claim 29 in which the edge region comprises part of a downwardly facing surface extending downstream with respect to the direction of travel of an article.

31. Apparatus as claimed in claims 29 or 30 including a guide arranged to direct an article from extending downwardly after the article passes the edge region to extending upwardly and above the level of fluid after the leading part of the article has passed the edge region.

32. Apparatus as claimed in claim 29 to 31 including conveyor means arranged to direct an article downwardly towards the edge region.
